(19) United States
(12) Patent Application Publication
(10) Pub. No.: US 2026/0325892 A1
(43) Pub. Date: Oct. 22, 2026

(54) Wildfire Fan Assembly

(71) Applicant: Bobby Nami, San Antonio, TX (US)

(72) Inventor: Bobby Nami, San Antonio, TX (US)

(21) Appl. No.: 19/653,338

(22) Filed: Apr. 21, 2026

Related U.S. Application Data
(60) Provisional application No. 63/791,812, filed on Apr. 21, 2025.

(51) Int. Cl. A62C 3/02

(52) U.S. Cl. CPC A62C 3/0207

(57) ABSTRACT

A wildfire fan assembly for defending property and life against wildfires comprises a frame assembly supporting a shroud, an engine, an aftercooler, and a radiator, and a propeller assembly powered by the engine. The propeller assembly is positioned within the shroud and driven by the engine to generate high-velocity airflow. One or more rudders extend from the shroud to direct that airflow toward a target area. One or more coupling hooks extend from the frame assembly for removable attachment to a vehicle, such as a wheel loader, enabling an operator in the vehicle cab to position, elevate, and control the fan assembly. In various embodiments, the fan assembly is configured to generate airflow in excess of 150 miles per hour.

### CROSS REFERENCES TO RELATED APPLICATION

This application claims priority to U.S. Provisional Application No. 63/791,812.

### FEDERALLY SPONSORED RESEARCH OR DEVELOPMENT

Not applicable.

### BACKGROUND OF THE INVENTION

### 1. Field of the Invention.

The present invention is directed towards improving technology used when defending private and public property, and human and animal life, against the destructive forces of wildfires. This invention improves the technology currently used to combat wildfires and related dangerous occurrences.

### 2. Description of the Related Art.

Various technologies have been employed in fighting wildfires since the late 1800s. Initially, firefighting relied primarily on human firefighters and water distribution. Modern approaches have evolved to include fire trucks, specialized land vehicles, aircraft, and helicopters that distribute water, fire retardant foams, and fire retardant powders. However, existing technologies have significant limitations. Ground-based approaches often place firefighters dangerously close to active fire zones, while maintaining a safe distance can reduce effectiveness. Aerial firefighting operations, while valuable, are restricted by environmental conditions, particularly smoke and high winds, which can ground aircraft and helicopters. These limitations highlight the need for more effective and safer firefighting solutions that can operate continuously in various conditions. In particular, there is a need for firefighting technology that can operate effectively and continuously in the smoky, high-wind, and extreme-heat conditions that are characteristic of active wildfire environments—conditions that frequently ground aircraft and helicopters and limit the effectiveness of ground-based water and retardant delivery systems. The present invention addresses this need by providing a ground-based, vehicle-mounted fan assembly capable of generating and directing high-velocity airflow toward a wildfire without requiring the operator to be exposed to the fire environment, and without the atmospheric limitations that restrict aerial firefighting operations.

The present invention uses wind to combat fires. When discussing wind conditions, it is useful to consider established wind classification systems. The Saffir-Simpson Hurricane Wind Scale (SSHWS) provides a framework for understanding wind speeds and their potential impacts. This scale classifies hurricanes by their sustained wind speeds in miles per hour (mph): Category 1 (74-95 mph), Category 2 (96-110 mph), Category 3 (111-129 mph), Category 4 (130-156 mph), and Category 5 (157 mph or greater).

The SSHWS serves to estimate potential damage and flooding from hurricanes upon landfall. While Category 1 hurricanes may cause minimal damage, Category 3 and higher hurricanes can result in devastating damage.

Wind machines exist for lab applications and product testing, but have not been used for stopping and extinguishing wildfires. Known wind machines have been used to simulate wind speed in various applications, including movie sets, testing camping tents, and testing hurricane-resistant housing products. Such machines are typically trailer mounted or stationary. Prior art wind machines are not known to use rudders for directional control, diesel engines as a power source, or mounting systems for attachment to wheel loaders or similar vehicles. Nor are prior art wind machines known to have been deployed to direct airflow toward an active fire, or equipped with vertical rudders to direct the discharged air toward a target.

### SUMMARY OF THE INVENTION

The present invention was developed to address the problems discussed above. The wildfire fan assembly described herein is intended to combat wildfires and similar conditions. The invention comprises a frame assembly supporting a shroud, an engine, an aftercooler, a radiator, and a propeller assembly powered by the engine. The propeller blades are positioned within the shroud. One or more rudders extend from the shroud, and one or more coupling hooks extend from the frame assembly. A front end loader having a quick coupler is intended to lift and support the frame assembly. The driver (“operator”) sitting inside of the loader cab can control the wildfire fan assembly. In various embodiments, the wildfire fan assembly is intended to generate airflow in excess of 150 miles per hour.

### BRIEF DESCRIPTION OF THE SEVERAL VIEWS OF THE DRAWINGS

For an improved understanding of the present invention, and the advantages thereof, reference is made to the following descriptions taken in conjunction with the accompanying drawings. The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a perspective view of the fan assembly showing the shroud, cage enclosure, and overall assembly profile.

FIG. 2 is a front view of the fan assembly showing the discharge face of the shroud and the three-blade propeller arrangement.

FIG. 3 is a rear view of the fan assembly showing the cage enclosure, engine area, and three-position coupler arrangement.

FIG. 4 is a side view of the fan assembly showing the full profile, including the shroud-to-cage relationship.

FIG. 5 is a top view of the fan assembly and coupler positions.

FIG. 6 is a perspective view of the fan assembly mounted on a loader with an operator in the cab.

FIG. 7 is a side view of the shroud assembly showing the three-section convergent geometry, with an arrow showing the direction of air flow when the fan assembly is in operation.

FIG. 8 is a detail view of the engine assembly showing the engine, aftercooler, radiator, radiator hoses, cooling package, air cleaner.

FIG. 9 is a second view of the engine assembly.

FIG. 10 is an overview of the rudder system showing the vertical rudders and horizontal rudders.

FIG. 11 is a second view of the rudder system.

FIG. 12 is an interior view of the skid area showing the engine, aftercooler, radiator, DEF fluid tank, batteries, air compressor and tank, in their relative positions within the cage enclosure.

FIG. 13 is an alternative embodiment showing the relationship between a cab-mounted joystick control and one of the rudder pairs.

FIG. 14A is a drawing of a cab-mounted engine control box showing the electronic throttle control, lighted gauges, voltmeter, temperature gauge, oil pressure gauge, tachometer, hour meter, fuel gauge, engine warning system, keyed ignition switch, fuse panel with circuit breakers, and associated switches. FIG. 14B is a drawing of a rudder control box showing the toggle controls for the vertical and horizontal rudder toggle switches.

FIG. 15 is a drawing of an external fuel tank for the fan engine assembly.

### DETAILED DESCRIPTION OF THE INVENTION

### 1. General Considerations

The present invention disclosure is for a wildfire fan assembly intended to defend private and public property, and human and animal life, against the destructive forces of wildfires. The invention is described by reference to various elements herein. It should be noted, however, that although the various elements of the inventive apparatus are described separately below, the elements need not necessarily be separate. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple repetitions of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### 2. Considerations Specific to the Invention

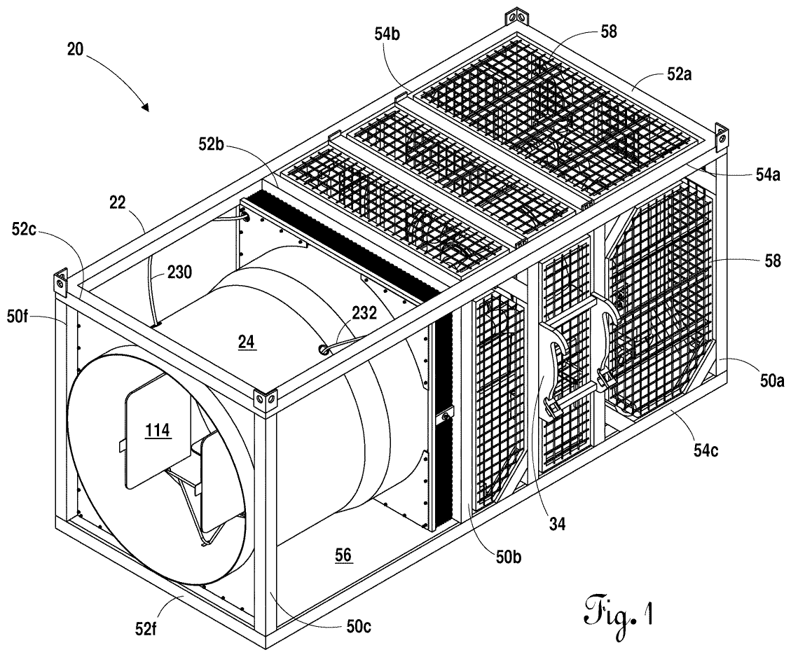

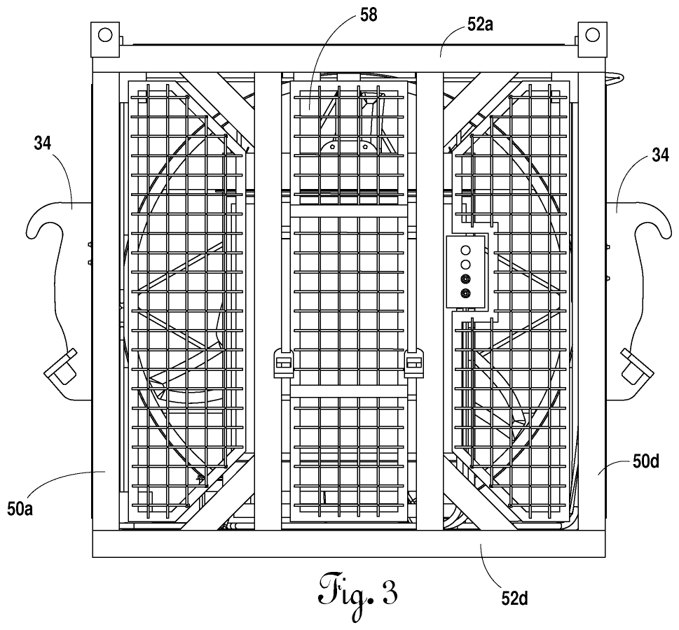

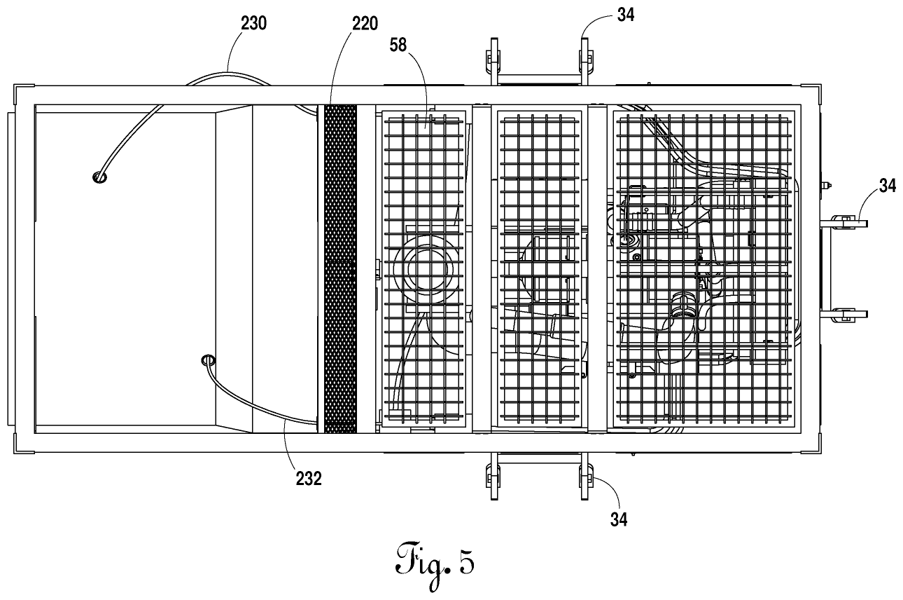

FIGS. 1 through 6 illustrate the preferred embodiment of the present invention, fan assembly 20. Fan assembly 20 is made up, in relevant part, of a frame assembly 22, a shroud 24, propeller blades 26, an engine 28, an aftercooler 30 (e.g., a turbo aftercooler), a radiator 32, radiator hoses 33 wrapped with thermal conduit 91, coupling hooks 34, rudders 114, 116, and a cage enclosure comprising welded screens 58. The relatedness of these several parts is discussed in greater detail below.

In the preferred embodiment, frame assembly 22 is made of steel beams that are painted. The metal beams include vertical beams 50a-50f, horizontal beams 52a-52f, and depth beams 54a-54d. The frame assembly defines a front frame 60, a rear frame 62, a middle frame 64, side frames 66, and a top frame 68. The bottom of the frame assembly is closed by a solid floor 56 formed in the space bounded by beams 52d, 52f, 54c, and 54d. The solid floor 56 provides structural rigidity and prevents debris from entering the underside of the assembly during operations. In the preferred embodiment, the frame is eight feet wide, fourteen feet long, and eight feet tall.

A cage enclosure surrounds the engine, drivetrain, and ancillary components in the area behind the shroud. The cage covers the top, two sides, and rear of the frame assembly. The front face of the frame assembly, where the shroud 24 is mounted, is open. The cage comprises welded wire screens 58 secured to the frame assembly. The welded screens prevent debris from entering the engine area and reduce operational hazards arising from personnel or animals coming into contact with moving or hot components during operations. The solid floor 56 closes the bottom of the cage enclosure.

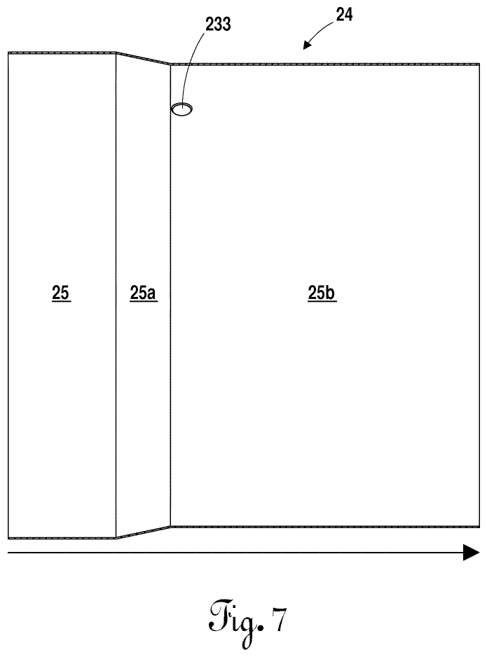

Shroud 24 is mounted at and circumscribed by the front frame 60 and extends rearward toward middle frame 64. As shown in FIG. 7, the shroud 24 has a convergent three-section profile. In this embodiment, the section nearest the engine (section 25) has a radius of approximately 47.5 inches, and the section at the discharge face (section 25b) has a radius of approximately 45.5 inches. The middle section (section 25a) provides a smooth transition between these two diameters. The convergent geometry of the shroud accelerates the airflow from the propeller disk toward the discharge face, contributing to the high discharge velocity of the assembly. The shroud is supported by shroud supports and shroud gussets connecting it to the frame assembly.

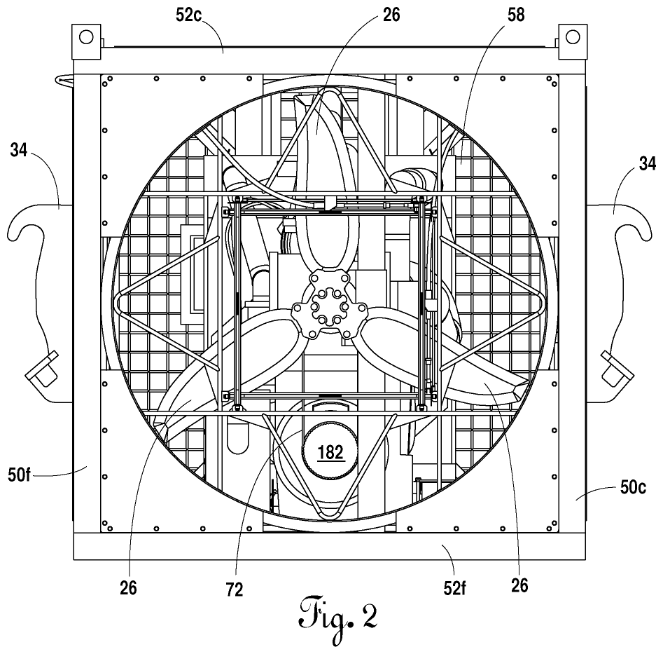

As shown in FIG. 2, the preferred embodiment employs three propeller blades 26 (e.g., Sensenich blades) mounted on a single propeller hub within the shroud 24. The propeller blades are of adjustable pitch and are matched to the engine horsepower and desired airflow velocity. The adjustable-pitch capability of the propeller blades allows the operator to optimize thrust output for prevailing conditions.

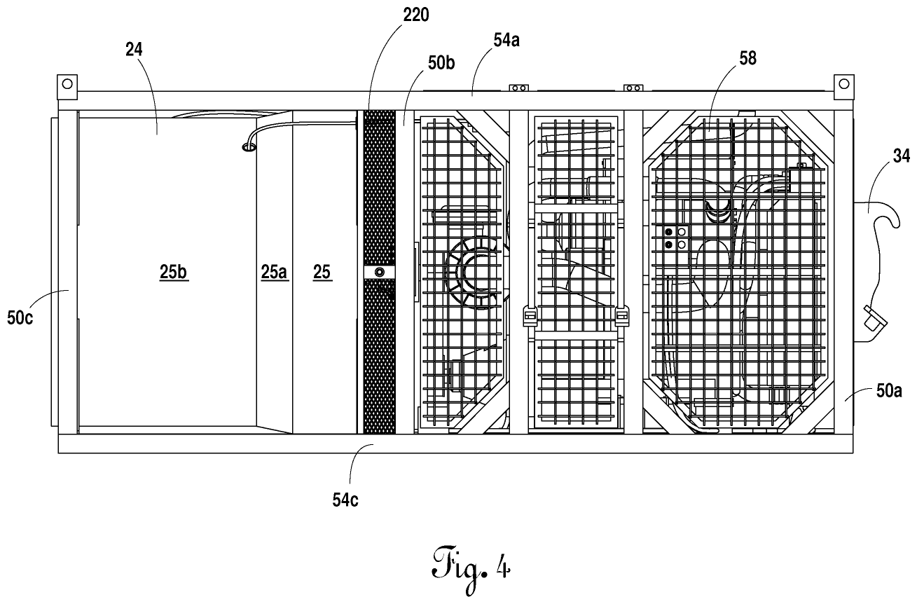

As shown in FIG. 4, much of the frame is enclosed with welded screens 58. A segment of the frame near the opening of the shroud 24 at section 25 is surrounded in diamond mesh 220. Diamond mesh is used at this segment for increased safety given its proximity to the blades 26.

The fan assembly is configured to generate high-velocity airflow through the combination of engine power, propeller blade geometry, shroud geometry, and drivetrain reduction ratio. In the preferred embodiment, a diesel engine delivering approximately 650 horsepower drives a three-blade, eighty-inch diameter, adjustable-pitch propeller assembly through a belt reduction drive unit 70 operating at a ratio of between 1.5:1 and 2.0:1, by way of example. Alternative embodiments might provide different ratios. The propeller assembly is positioned within the convergent shroud 24 having a radius of approximately 47.5 inches at the engine end and approximately 45.5 inches at the discharge face. The convergent geometry of the shroud accelerates the airflow from the propeller disk toward the discharge face, contributing to the high discharge velocity of the assembly. This combination of engine power, blade geometry, reduction ratio, and convergent shroud geometry is calculated to generate airflow in excess of 150 miles per hour at the discharge face of the shroud. A person of ordinary skill in the art of fluid dynamics and mechanical engineering would understand how to select engine horsepower, blade diameter, blade pitch, blade count, reduction ratio, and shroud geometry to achieve a target airflow velocity, and would understand that the specific values described herein are illustrative of one configuration capable of achieving airflow in excess of 150 miles per hour.

Although the diameter of the propeller blades may vary, blades having a diameter of at least sixty inches are contemplated as capable of generating the high-velocity airflow necessary for wildfire suppression applications when paired with an appropriately sized engine. A person of ordinary skill in the art would understand how to select blade diameter in conjunction with engine horsepower, blade count, blade pitch, and reduction ratio to achieve a desired airflow output.

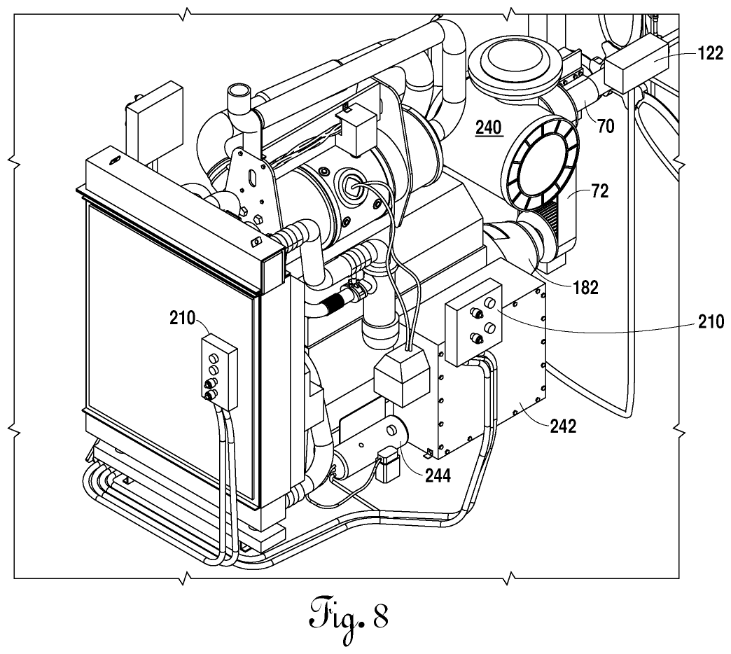

As shown in FIG. 8, the engine 28 and radiator 32 are attached to the frame assembly 22 by engine stand supports 80. In the preferred embodiment, the engine 28 is a 13.6 L six-cylinder inline, four-stroke, water-cooled diesel engine with a power rating of approximately 650 hp and rated torque of approximately 1,851 foot-pounds (e.g., the John Deere JD14). The engine is turbocharged and includes a complete cooling package with core guard 82 and a two-stage air cleaner 240. Intake air is drawn through the air filter 240 and passes through a breather 246 en route to the engine 28. The aftercooler 30 (e.g., a turbo aftercooler) cools the compressed intake air downstream of the turbocharger before it enters the engine combustion chamber, improving engine efficiency and power output. Radiator hoses 33 are wrapped with thermal conduit 91 to protect them from radiant heat during wildfire suppression operations. The radiator 32 dissipates heat from the engine coolant, maintaining the engine 28 within its operating temperature range during sustained wildfire suppression operations. The engine 28 has a dry weight of approximately 3,236 pounds. For at least that reason, the fan assembly requires a loader 40—or other vehicle—capable of lifting and supporting the assembly. A DEF (Diesel Exhaust Fluid) tank 242 is positioned adjacent to the engine 28 and supplies fluid to the engine's emissions control system.

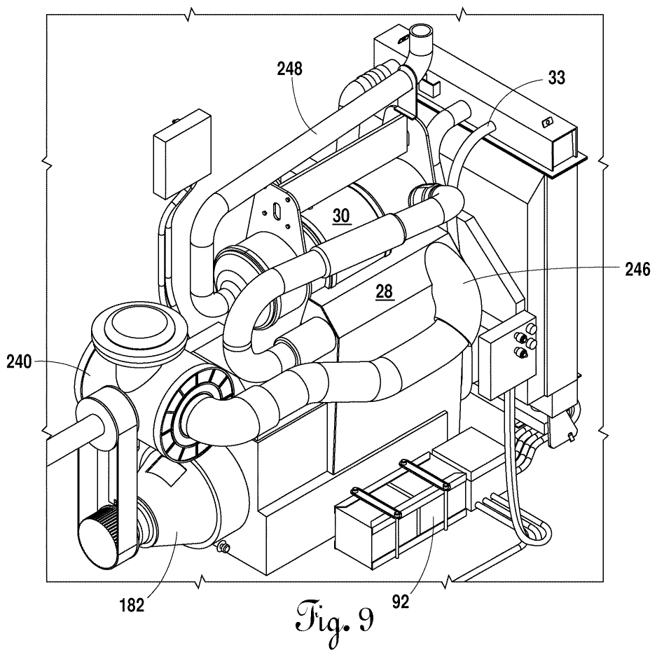

As shown in FIG. 9, the drivetrain of the fan assembly transfers engine power to the propeller blades 26 through a series of connected components. An air-operated power take-off (PTO) 182 is connected to the flywheel of the engine 28 and serves as the clutch for the drivetrain, allowing the operator to smoothly engage and disengage engine power from the drivetrain for startup and shutdown. As used herein, the term “PTO” refers to a mechanism that transfers engine power to an auxiliary drivetrain while also providing engage/disengage functionality equivalent to a clutch. The air compressor 244 supplies the compressed air necessary to operate the PTO 182. When engaged, the PTO 182 turns a shaft connected to the belt and pulley assembly 72, which in turn drives a shaft connected to the belt reduction drive unit 70. The belt reduction drive unit 70 is connected to the propeller hub, which drives the propeller blades 26. In the preferred embodiment, the belt reduction drive unit 70 operates at a reduction ratio of between 1.5:1 and 2.0:1, by way of example; alternative embodiments may employ different ratios. The belt reduction drive unit 70 is mounted on a vertical beam of the frame assembly in an adjustable configuration. When the mounting is loosened, the operator can slide the belt reduction drive unit 70 along the vertical beam to adjust belt tension or to remove and replace the belt of the belt and pulley assembly 72, allowing for field maintenance of the drivetrain without requiring removal of the fan assembly from the loader. In some embodiments, the PTO 182 is supported by a PTO support plate mounted to the floor 56. Exhaust gases leaving the engine 28 are directed out of the assembly through exhaust line 248, which routes exhaust away from the shroud discharge face and heat-sensitive components.

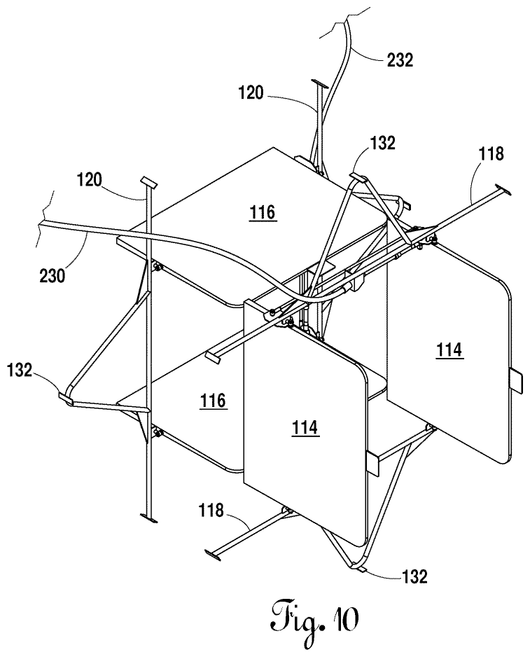

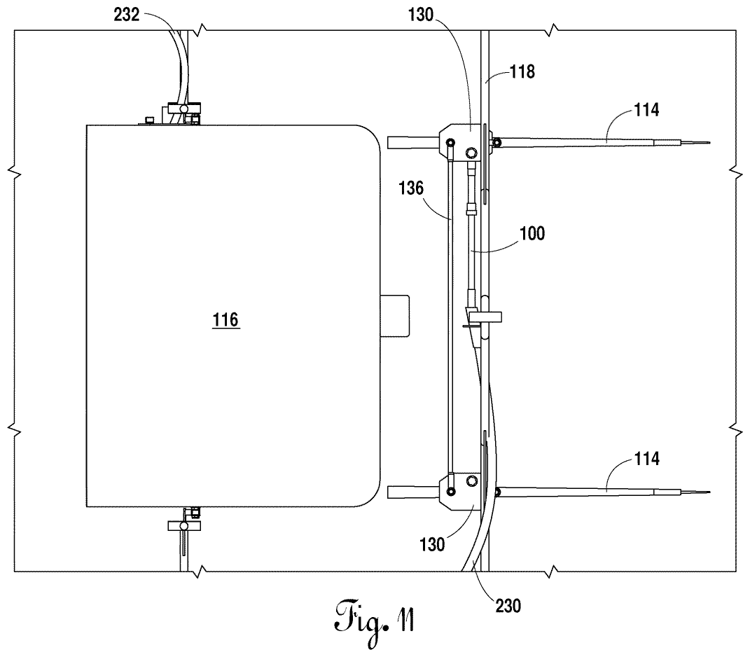

As shown in FIGS. 10 and 11, the preferred embodiment incorporates both vertical rudders 114 and horizontal rudders 116, which together provide the operator with independent control over two axes of airflow direction. The vertical rudders 114 allow the operator to direct the airflow laterally, that is, to the left or right relative to the fan assembly, while the horizontal rudders 116 allow the operator to control the elevation angle at which the airflow is discharged toward the fire. Together, vertical and horizontal rudders allow the operator to aim the high-velocity airflow with precision at different areas of an active fire, including ground-level fuel, elevated flame, or burning structures, without repositioning the vehicle or the fan assembly. The rudders 114, 116 are mounted to the shroud 24 by way of mounting brackets 132. In this embodiment, the mounting brackets 132 exhibit a lean profile so as to not disrupt the flow of air/wind through the shroud 24.

The aluminum rudders 114, 116 are mounted on pivot axes 130, allowing each set of rudder assemblies to be controlled independently. In the preferred embodiment, the rudders extend from the shroud 24. Although the rudders in the preferred embodiment are illustrated as extending from the shroud, it is contemplated that in alternative embodiments the rudders may extend from the frame assembly, including the rear frame, a side frame, or the frame assembly generally, without departing from the scope of the invention. The operative function of the rudders (i.e., directing the airflow discharged by the propeller assembly toward a desired target) may be achieved regardless of the specific portion of the frame assembly from which the rudders extend. In the preferred embodiment, four rudders are employed, two vertical rudders 114 and two horizontal rudders 116, each having a length of approximately four feet.

As shown in FIG. 11, rudder actuation in the preferred embodiment is accomplished by an electronic actuator. A first electronic actuator 122 is mechanically connected to the vertical rudders 114 via a linkage assembly/cable 230. The cable 230 passes through the shroud 24 at one of the cable ports 233 and connects to rudder rod 100 and heim joints 104 specific to the vertical rudders. A second electronic actuator 123 is separately and independently connected to the horizontal rudders 116 via a corresponding linkage assembly/cable 232 and connects to a corresponding rudder rod 100 and heim joints 104 specific to the horizontal rudders. The heim joints 104 accommodate the angular movement of the rudder rods 100 as the rudders rotate about their respective pivot axes 130, while maintaining a positive mechanical connection. Extension or retraction of each electronic actuator moves the corresponding rudders to the desired position and holds them in position. The operator controls the vertical rudder actuator 122 via a first toggle control 126 and the horizontal rudder actuator 123 via a second toggle control 127, both mounted in the cab of the loader. Unlike a steering cable arrangement, the electronic actuators maintain the rudders in position without requiring the operator to hold a control input, reducing operator fatigue and improving control precision during sustained wildfire suppression operations.

FIG. 11 also shows a brace 136 connecting the axis 130 of each of the vertical rudders 114, which facilitates parallel movement. Although not shown, the pair of horizontal rudders are similarly connected by a brace 136 at their pivot axes.

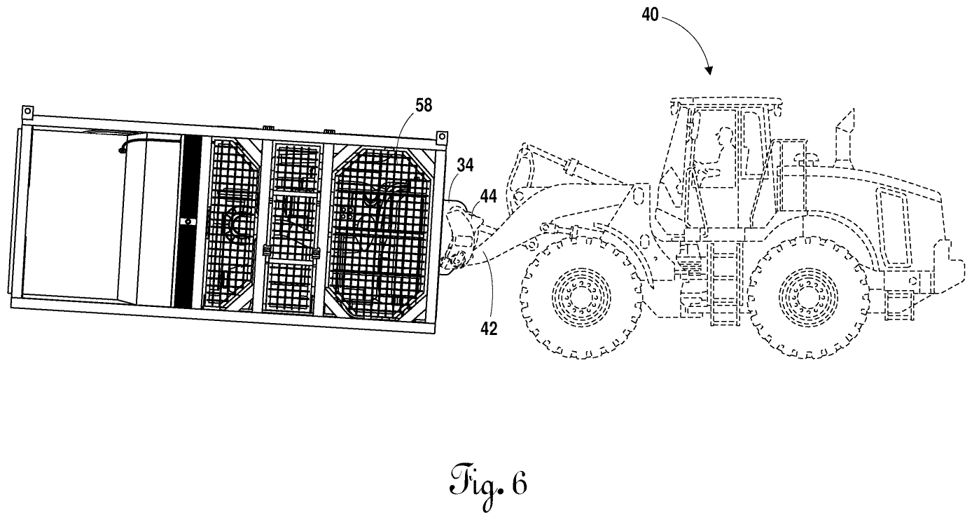

As shown in FIG. 6, a loader 40 having lifting arms 42 and a coupler 44 is contemplated for mounting, adjusting, and operating the fan assembly 20. Given the weight of the engine 28 and other equipment on the fan assembly 20, the loader 40 (or other vehicle) needs to be sufficiently strong and mobile to support and maneuver the fan assembly. In the preferred embodiment, a medium wheel loader such as the 966 or 966 GC loaders by CAT® is contemplated. The coupling hooks 34 extending from the frame assembly are configured for removable attachment to the loader's lifting arms via a hydraulic operated quick coupler 44. The quick coupler has two hydraulic operated pins that insert into the bottom of the coupling hook to secure the fan assembly for lifting. The particular form of the coupling hook may vary depending on the coupler system employed by the vehicle to which the fan assembly is to be attached. The removable nature of the connection allows for repositioning of the fan assembly during wildfire suppression operations.

In the preferred embodiment, three sets of coupling hooks 34 are positioned on three different sides of the frame assembly, giving the operator options as to mounting orientation depending on operational requirements. Although the preferred embodiment positions coupling hooks at multiple locations on the frame assembly, it is contemplated that the position, number, and configuration of coupling hooks may vary across embodiments. Coupling hooks may extend from the rear frame, the front frame, a side frame, or multiple frames of the frame assembly.

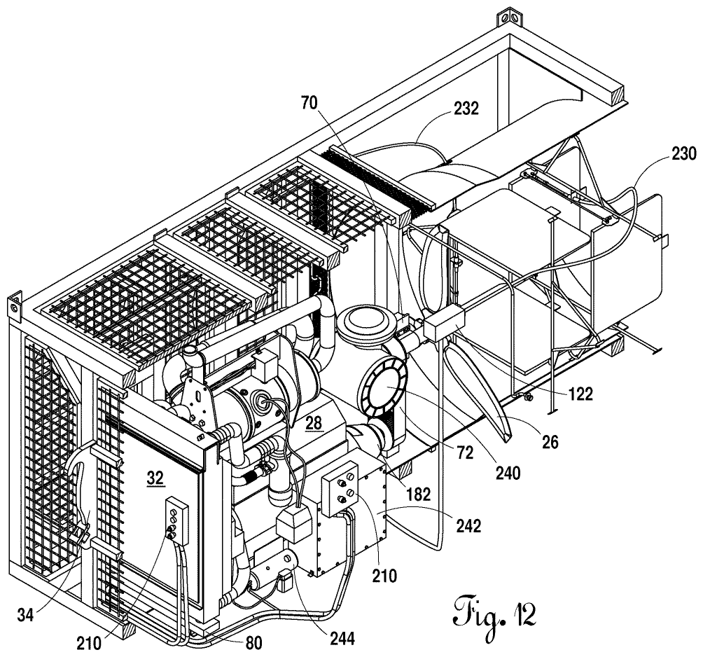

As shown in FIG. 12, the interior of the cage enclosure houses the engine 28, aftercooler 30, radiator 32, fuel tank 96, dual deep cycle batteries 92, ignition-protected battery selector switch 94, engine control panel 108, and wiring harness 110. In embodiments employing electronic actuators, the air compressor 244 operates as an auxiliary system independent of the rudder actuation. The fuel tank 96 is an aluminum tank having a capacity of approximately 200 gallons, used to fuel the fan assembly diesel engine 28. The dual deep cycle batteries 92 are housed in battery boxes and connected through an ignition-protected battery selector switch 94. The engine control panel 108 is connected to the fan assembly by a wiring harness 110 enclosed in thermal conduit 91 of approximately 25 feet in length, allowing the operator to control the fan assembly from the cab of the loader or from another position some distance away.

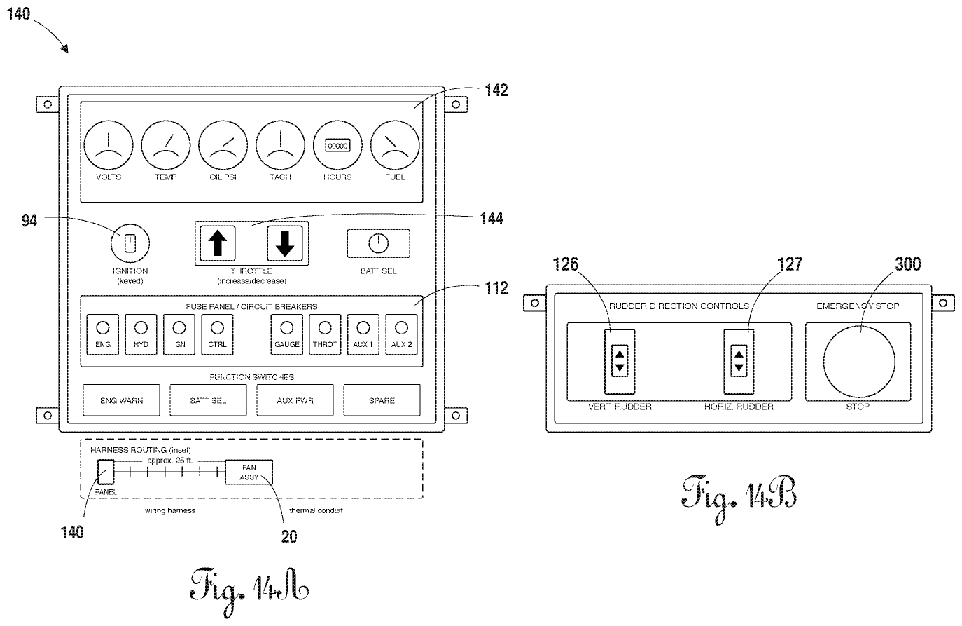

As shown in FIGS. 14A and 14B, additional cabin-mounted instrumentation is provided to monitor and control the fan assembly 20. This instrumentation includes a fan assembly control panel 140 with lighted gauges 142, labeled switches, voltmeter, temperature gauge, oil pressure gauge, tachometer, hour meter, fuel gauge, engine warning system, keyed ignition switch, fuse panel with circuit breakers 112, and up/down push arrows to control the throttle 144. The operator can increase the rpm of the fan by pressing the “up” button. Similarly, the operator can decrease the rpm of the fan by pressing the “down” button. The cab-mounted rudder control box, shown in FIG. 14B, includes toggle control 126 for the vertical rudder actuator 122 and toggle control 127 for the horizontal rudder actuator 123. The cab-mounted rudder control box also includes an emergency stop 300. Each toggle control allows the operator to independently position the corresponding set of rudders to the desired angle without leaving the cab of the loader. Once the desired rudder position is achieved, the actuator holds the rudders in place without requiring the operator to maintain continuous input. These instruments allow the operator to monitor and operate the fan assembly. The operator may adjust the height and angle of the fan assembly using the lifting arms of the loader and related assemblies.

The fan assembly is designed for operation in the high-heat environment proximate to an active wildfire. Thermal protection measures incorporated into the assembly include thermal conduit 91 encasing the radiator hoses, wiring harness, and other heat-sensitive connections, as well as heat deflection guards 90 positioned to protect heat-sensitive components from radiant heat. The engine 28 includes a complete cooling package with core guard 82 and a two-stage air cleaner 240 designed for operation in high-ambient-temperature and high-particulate environments. The frame assembly materials, shroud, and other structural components are selected for resistance to the elevated temperatures encountered during wildfire suppression operations. A person of ordinary skill in the art would understand how to select materials and protective measures appropriate for sustained operation in a wildfire environment.

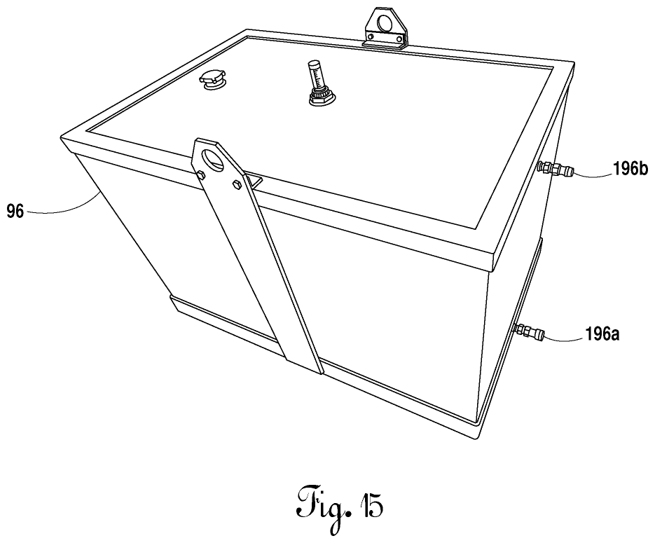

FIG. 15 is a drawing of an external fuel tank 96 for the fan assembly. In this embodiment, the fuel tank 96 is made of aluminum and has a capacity of 200 gallons. Fuel tank 96 contains a bottom outlet 196a and a top inlet 196b. Although not shown, in many embodiments, fuel tank 96 mounts to the rear of the loader. Fuel lines run between the fuel tank 96 and fan assembly 20 at one of the three quick connect fittings 210. Fuel exits the fuel tank at outlet 196a and runs to the quick connect fitting 210 where it fuels the assembly. Excess fuel returns through quick connect fitting 210 to the fuel tank 96 at inlet 196b. The operator may connect the fuel lines to the quick connect fitting on whichever side of the fan assembly is closest to the operator. For example, if the operator is coupling the loader to the rear of the fan assembly, the operator may connect the fuel lines to the quick connect fitting positioned on the rear side of the fan assembly. By contrast, the operator would connect the fuel lines to the quick connect fitting positioned on the left side of the fan assembly if the operator couples the loader to the left side of the fan assembly.

Quick connect fitting 210 has two additional caps, which are intended to receive cabling for (1) the engine control box (shown in FIG. 14A), and (2) the toggle switch box for the rudders (shown in FIG. 14B).

### 3. Method of Use

The present invention also encompasses a method of suppressing a wildfire using the fan assembly described herein. In one embodiment, the method comprises positioning the fan assembly 20 proximate to an active wildfire by attaching the fan assembly to a vehicle—such as a wheel loader 40—via one or more coupling hooks 34 and driving the vehicle to a desired location. Once positioned, the operator activates the engine 28, which drives the propeller assembly 26 through the reduction unit 70 to generate a high-velocity airflow directed toward the fire. In various embodiments, the engine and propeller assembly are configured such that the method generates airflow in excess of 150 miles per hour at the discharge face of the shroud 24, sufficient to suppress or redirect an active wildfire. The operator adjusts the direction of the airflow by actuating the toggle controls 126, 127 to manipulate the vertical rudders 114 and horizontal rudders 116, respectively extending from the shroud, directing the airflow laterally or at a desired elevation angle toward the active fire or surrounding fuel. The operator may reposition the fan assembly during operations by maneuvering the vehicle, adjusting the height of the fan assembly using the vehicle's lifting arms 42, or adjusting the rudder angles. The method may be performed continuously and does not require the operator to leave the cab of the vehicle during wildfire suppression operations.

In embodiments incorporating both vertical and horizontal rudders, the step of adjusting the direction of the airflow may comprise independently actuating the vertical rudders 114 to direct the airflow laterally and actuating the horizontal rudders 116 to control the elevation angle of the airflow. For example, the operator may actuate the vertical rudders to direct the airflow toward a specific area of the fire perimeter, and simultaneously or sequentially actuate the horizontal rudders to direct the airflow downward toward ground-level fuel or upward toward elevated flame. This independent two-axis control allows for precise targeting of the airflow without requiring physical repositioning of the fan assembly or vehicle. In embodiments employing an electronic actuator for each rudder axis, the operator need not maintain continuous pressure on any control input—the electronic actuators hold the rudders in position once set, allowing the operator to focus on vehicle positioning and other operational tasks.

### 4. Alternative Embodiments

In some embodiments, one or more of the welded screens 58 forming the cage enclosure may be replaced with operable screen doors, allowing access to the engine and other components for maintenance purposes without removing the screen panels. Such screen doors may be hinged, sliding, or otherwise configured to allow opening and closing as needed. In further alternative embodiments, a cage enclosure may also surround the shroud 24 in addition to the engine area, providing additional protection for the shroud and propeller assembly.

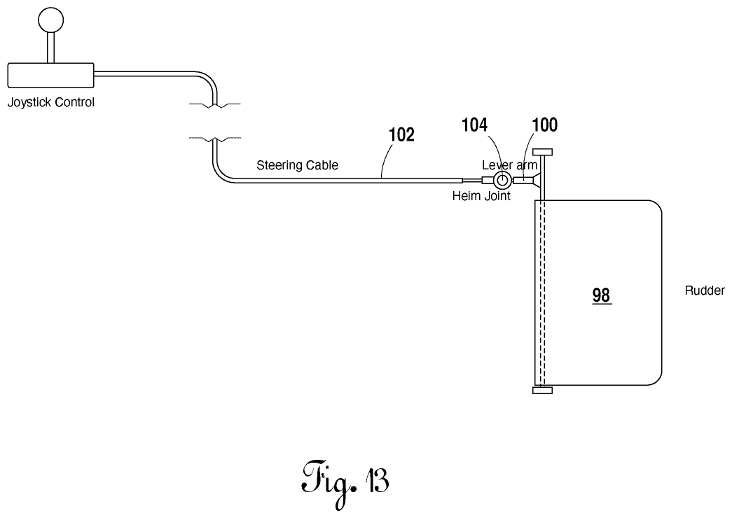

In some embodiments, rudder actuation may be accomplished by a joystick or handle connected to a push/pull steering cable rather than an electronic actuator, as illustrated in FIG. 13. In such embodiments, one or more rudders 98 are connected to a steering cable 102 via rudder rods 100 and heim joints 104, which provide a mechanical linkage between the operator's control handle and the rudders. The operator manipulates a joystick or similar control handle, which transmits force through the push/pull steering cable 102 to position the rudders to the desired angle. Unlike the electronic actuator embodiment, the operator must physically hold the handle in the desired position to maintain rudder positioning. In this alternative embodiment, one pair of rudders—either the vertical pair or the horizontal pair—is employed. The steering cable and associated components are preferably encased or protected by thermal conduit 91 to protect them from heat generated during wildfire suppression operations. A person of ordinary skill in the art would understand how to configure cable routing, heim joint sizing, and rudder rod geometry to achieve reliable rudder actuation of the type described herein.

In some embodiments, the propeller assembly may employ more than three blades. For example, a twelve-blade configuration may be employed in embodiments where greater airflow volume is desired at lower rotational speeds. In some embodiments, the device might include a greater or fewer number of propellers.

In some embodiments, the belt reduction drive unit 70 may operate at a different reduction ratio, or the device might include no reduction equipment, with the propeller driven directly by the engine. In some embodiments, the device might include a different drive arrangement to change the ratio between engine speed and propeller speed.

In some embodiments, the frame assembly may form a different shape than a rectangular prism. For example, the frame could be a cube, a triangular prism, or a cylinder. In some embodiments, the frame might be constructed of materials other than metal, such as composite materials, plastic, or wood.

In some embodiments, the device might include a greater or fewer number of coupling hooks, and the coupling hooks might appear in different arrangements or positions on the frame assembly. In some embodiments, the coupling hooks might appear on one or both sides, the rear frame, or other portions of the frame assembly.

In some embodiments, the device might be placed on a trailer or fixed in place. Such embodiments might have less mobility or adjustability than a loader-mounted embodiment but may be suitable for deployment at a fixed perimeter position during wildfire suppression operations. In further alternative embodiments, the device could be attached to or suspended from an aircraft.

The present invention may apply to fields other than wildfire suppression. Examples include entertainment productions, product testing, and weather testing.

### 5. Additional Considerations

This application has presented several embodiments of the present invention and discussed various devices. It is contemplated that these units and devices may exist in varying arrangements, combinations, and still reflect the spirit of the present invention. The present invention may be incorporated into other assemblies, which may have additional capacities, capabilities, and/or applications.

The present invention is described above in terms of a preferred illustrative embodiment in which a specifically described wildfire fan assembly is described. Those skilled in the art will recognize that alternative constructions of such an apparatus, system, and method can be used in carrying out the present invention. Other aspects, features, and advantages of the present invention may be obtained from a study of this disclosure and the drawings, along with the appended claims.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the term “wire panels” encompasses both welded screen panels and operable screen doors, regardless of whether the panels are permanently fixed or configured to be opened and closed.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating the wildfire fan assembly through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

We claim:

1. A fan assembly comprising:
a frame assembly comprising a front frame, a rear frame, and a bottom frame, the front frame existing perpendicularly at a proximal end of the bottom frame, the rear frame existing perpendicularly at a distal end of the bottom frame;
at least one coupling hook extending from the rear frame;
a shroud circumscribed by the front frame, the shroud extending from the front frame toward the rear frame;
at least one propeller positioned within the shroud;
an engine connected to the propeller and connected to the bottom frame;
an aftercooler connected to the engine; and
a radiator connected to the engine.

2. The fan assembly of claim 1 wherein the at least one coupling hook is configured for removable attachment to a vehicle.

3. The fan assembly of claim 1 further comprising one or more rudders extending from the shroud.

4. The fan assembly of claim 3 wherein an electric actuator is connected to the one or more rudders.

5. The fan assembly of claim 1 further comprising a middle frame existing perpendicularly with the bottom frame and positioned between the rear frame and the front frame; the shroud extending from the front frame to the middle frame.

6. The fan assembly of claim 1 wherein the bottom frame is solid.

7. The fan assembly of claim 1 wherein the front frame and the rear frame each comprise wire panels.

8. The fan assembly of claim 1 wherein the frame assembly is constructed of metal, and wherein the at least one propeller comprises a plurality of adjustable-pitch propeller blades each having a diameter of at least sixty inches.

9. A fan assembly for directing airflow, the fan assembly comprising:
a frame assembly comprising a front frame, a rear frame, and a bottom frame;
at least one propeller positioned within a shroud connected to the frame assembly;
an engine connected to the at least one propeller; and
one or more rudders extending from the shroud and configured to direct airflow discharged by the at least one propeller.

10. The fan assembly of claim 9 wherein the one or more rudders comprise at least one vertical rudder and at least one horizontal rudder.

11. The fan assembly of claim 9 wherein one or more electronic actuators are connected to the one or more rudders.

12. The fan assembly of claim 9 wherein the one or more rudders are connected by one or more linkage assemblies to one or more actuators configured to allow an operator to adjust the direction of the airflow.

13. The fan assembly of claim 9 comprising four rudders, each rudder having a length of approximately four feet.

14. The fan assembly of claim 9 further comprising at least one coupling hook extending from the frame assembly, the at least one coupling hook configured for removable attachment to a vehicle.

15. A method of suppressing a wildfire comprising:
positioning a fan assembly proximate to a wildfire using a vehicle, the fan assembly comprising a frame assembly, at least one propeller positioned within a shroud connected to the frame assembly, an engine connected to the at least one propeller, and at least one coupling hook extending from the frame assembly removably connected to the vehicle;
operating the engine to drive the at least one propeller and generate an airflow directed toward the wildfire; and
adjusting the direction of the airflow using one or more rudders extending from the shroud.

16. The method of claim 15 wherein the vehicle is a wheel loader, and wherein an operator controls both the vehicle and the fan assembly from a cab of the wheel loader.

17. The method of claim 15 wherein the airflow generated by the fan assembly exceeds 150 miles per hour.

18. The method of claim 15 wherein adjusting the direction of the airflow comprises actuating at least one vertical rudder and at least one horizontal rudder.
